(19) United States
(12) Patent Application Publication
(10) Pub. No.: US 2026/0004197 A1
(43) Pub. Date: Jan. 1, 2026

(54) Reinforcement Learning Engine for Adaptive Influence Optimization

(71) Applicant: George William Bickerstaff, III, Greenwich, CT (US)

(72) Inventor: George William Bickerstaff, III, Greenwich, CT (US)

(21) Appl. No.: 19/309,743

(22) Filed: Aug. 26, 2025

(51) Int. Cl. G06N 20/00; H04L 9/06

(52) U.S. Cl. CPC G06N 20/00; H04L 9/0631

(57) ABSTRACT

The Reinforcement Learning Engine (RLE) optimizes influence scoring in digital ecosystems by aggregating dynamic metrics (e.g., engagement rates, trust scores), applying Proximal Policy Optimization (PPO)-based reinforcement learning with tailored reward functions, adjusting parameters via real-time behavioral feedback, generating optimized influence scores, and delivering secure JSON outputs via an API. The system includes a metric aggregation module, reinforcement learning processor, interaction adjustment unit, influence optimizer with audit logging, and secure output interface. The method ingests metrics, learns from multi-agent interactions, tunes parameters, optimizes scores, and ensures GDPR-compliant, privacy-preserving operations with immutable audit trails. Applications include decentralized governance and reputation management in distributed networks, overcoming limitations of static scoring systems.

### CROSS-REFERENCE TO RELATED APPLICATIONS

This application claims priority to U.S. Provisional Patent Application No. 63/847,329, filed Jul. 20, 2025, the entire contents of which are incorporated herein by reference.

### Cpc Classifications

G06Q 50/01: Organizational management; social networking
G06F 16/9535: Structured data optimization
G06N 20/00: Machine learning applications
H04L 9/32: Cryptographic security
G06N 3/08: Reinforcement learning systems

### DEFINITIONS

For clarity, the following terms are defined (alphabetically):
Adaptive Learning: A process that adjusts parameters in real-time based on feedback to enhance influence scoring accuracy.
Audit Logger: A component recording optimization actions and GDPR compliance in immutable blockchain storage.
GDPR: General Data Protection Regulation, an EU framework for secure data processing and privacy.
Influence Metrics: Quantitative measures (e.g., likes, shares, peer endorsements, governance alignment scores) from social or blockchain platforms.
Reinforcement Learning (RL): A machine learning approach where agents optimize actions through trial, error, and reward-based feedback.

### FIELD OF THE INVENTION

This invention relates to data processing systems using reinforcement learning for adaptive optimization of influence metrics in digital governance, reputation management, and distributed network applications.

### BACKGROUND OF THE INVENTION

Static influence scoring models, such as those based on fixed metrics like follower counts or likes, fail to adapt to dynamic trust and behavioral patterns in decentralized ecosystems. Existing systems lack real-time adaptability, robust auditing, and privacy-preserving mechanisms. As digital governance and reputation management expand, a reinforcement learning-based engine is needed for dynamic, auditable, and GDPR-compliant influence scoring. A review of prior art (USPTO and Google Patents, August 2025) reveals:

| | Document | | | |
|---|---|---|---|---|
| Reference | Number | Description | Limitation | Verification |
| US20210027647A1 | US20210027647A1 | Adaptive | General ML; no | Public Search; |
| (2021) | | machine learning | RL for influence | USPTO Patent |
| | | system | | focuses on broad |
| | | | | ML |
| U.S. Pat. No. | U.S. Pat. No. | Reinforcement | General RL; no | USPTO; focuses |
| 9,679,258B2 (2017) | 9,679,258B2 | learning methods | influence focus | on RL techniques |
| U.S. Pat. No. | U.S. Pat. No. | Deep RL for ESS | Energy-specific; | USPTO; limited |
| 11,610,214B2 (2023) | 11,610,214B2 | scheduling | no influence | to energy |
| | | | optimization | scheduling |
| U.S. Pat. No. | U.S. Pat. No. | Blockchain trust | Consensus- | USPTO; |
| 10,360,191B2 (2019) | 10,360,191B2 | validation | focused; lacks | addresses |
| | | | RL | blockchain |
| | | | | consensus |
| US20170046689A1 | US20170046689A1 | Crypto voting | Social data | USPTO; focuses |
| (2017) | | and social | aggregation; no | on crypto voting |
| | | aggregation | RL | |

These references do not integrate reinforcement learning with influence optimization, auditing, or privacy-preserving mechanisms, which this invention addresses through a novel RL-based engine.

### SUMMARY OF THE INVENTION

The Reinforcement Learning Engine (RLE) provides a system and method for adaptive influence optimization in digital ecosystems. It aggregates metrics (e.g., engagement, trust), applies PPO-based reinforcement learning with custom reward functions, adjusts parameters in real-time, generates optimized influence scores, and delivers secure JSON outputs. Key components include a metric aggregation module, RL processor, interaction adjustment unit, influence optimizer with audit logging, and output interface. The system ensures GDPR compliance through anonymization and immutable logs, enabling applications in decentralized governance and reputation management. Benefits include real-time adaptability, privacy preservation, and interoperability with distributed networks.

### BRIEF DESCRIPTION OF THE DRAWINGS

The drawings illustrate embodiments of the invention, submitted separately per 37 CFR § 1.81.

FIG. 1: System Architecture Overview, depicting data flow across components.

FIG. 2: Metric Processing Pipeline, detailing RL feedback mechanisms.

FIG. 3: Learning Adjustment Framework, for real-time parameter tuning.

FIG. 4: Optimization Workflow, for generating influence scores.

FIG. 5: Output Processes Flowchart, for secure delivery and integration.

### LIST OF FIGURES WITH REFERENCE NUMBERS

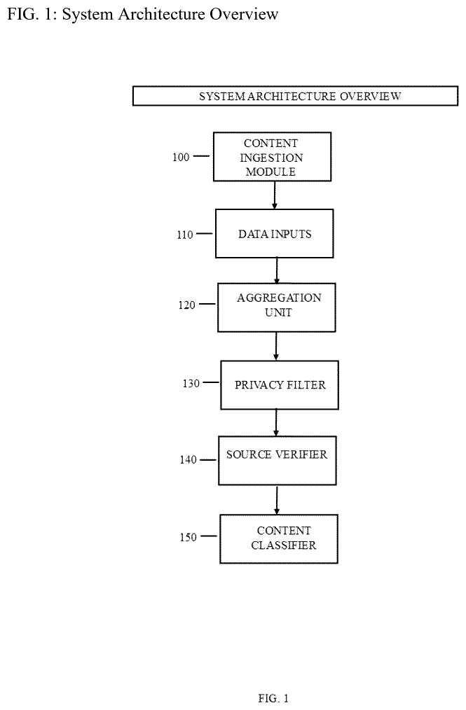

FIG. 1: System Architecture Overview
100: Metric Aggregation Module
110: Data Inputs
120: Aggregation Unit
130: Privacy Filter
140: Source Verifier
150: Metric Classifier

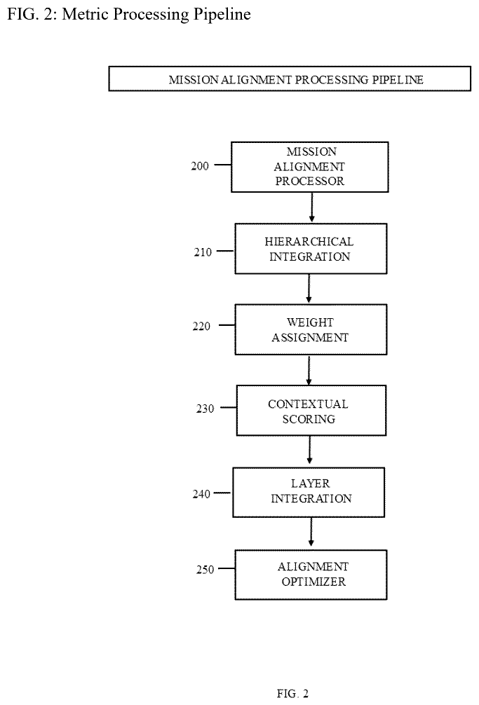

FIG. 2: Metric Processing Pipeline
200: RL Processor
210: Feedback Handling
220: Reward Function
230: Model Training
240: Parameter Optimization
250: Learning Feedback Loop

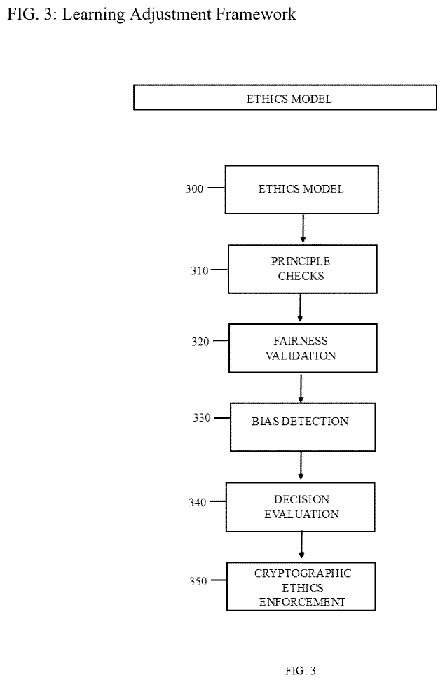

FIG. 3: Learning Adjustment Framework
300: Interaction Adjustment Unit
310: Real-Time Inputs
320: Parameter Tuning
330: Behavior Analysis
340: Adjustment Validation
350: Dynamic Calibration

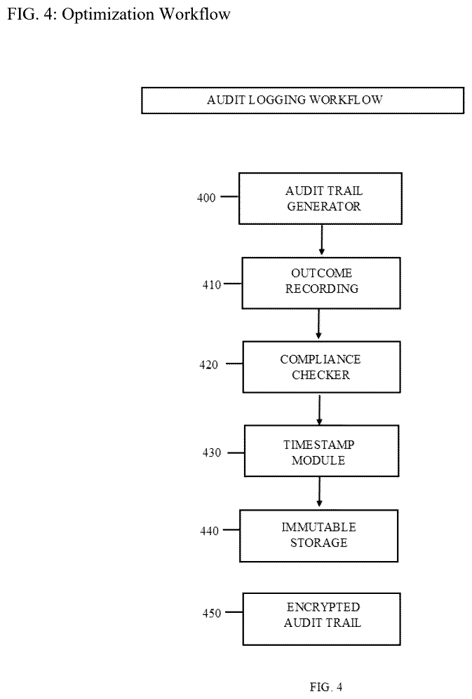

FIG. 4: Optimization Workflow
400: Influence Optimizer
410: Score Compilation
420: Timestamp Module
430: Immutable Storage
440: Privacy-Preserving Optimization
450: Audit Logger

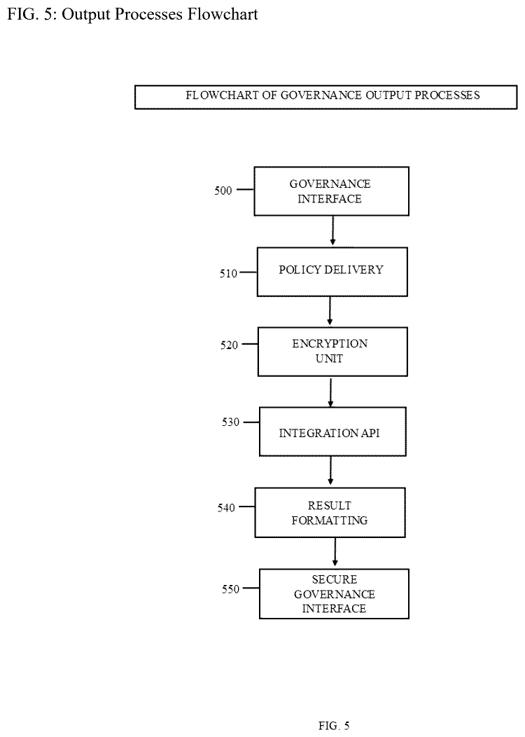

FIG. 5: Output Processes Flowchart
500: Output Interface
510: Result Delivery
520: Encryption Unit
530: Integration API
540: Result Formatting
550: Secure Transmission

### DETAILED DESCRIPTION OF THE INVENTION

This section describes the construction and operation of the Reinforcement Learning Engine (RLE), with reference to the drawings. Modifications are possible within the scope of the invention.

### System Overview

As depicted in FIG. 1 (ref. 100), the RLE operates in distributed environments (e.g., cloud or blockchain), dynamically optimizing influence scores. It processes metrics from social platforms (e.g., Twitter, LinkedIn), blockchain ledgers (e.g., Ethereum), or analytics databases, ensuring GDPR compliance through encryption, anonymization, and minimal data retention. Applications include decentralized governance (e.g., DAO voting) and reputation management (e.g., trust scoring).

### Core Components

1. Metric Aggregation Module (FIG. 1, ref. 100) This module ingests metrics (ref. 110), such as engagement rates (e.g., 100 likes/hour), reputation scores (e.g., 0-100 trust index), and governance alignment (e.g., DAO vote participation). The aggregation unit (ref. 120) consolidates JSON/CSV inputs, the privacy filter (ref. 130) anonymizes data using SHA-256 hashing per GDPR, the source verifier (ref. 140) authenticates blockchain data via ECDSA signatures, and the metric classifier (ref. 150) applies k-means clustering for efficient categorization.

2. Reinforcement Learning Processor (FIG. 2, ref. 200) This processor manages feedback (ref. 210) from interactions (e.g., user endorsements) and applies a PPO-based reward function (ref. 220), defined as R=0.6*Engagement+0.3*Trust+0.1*Governance, where Engagement is normalized likes/shares, Trust is peer endorsements, and Governance is vote alignment. Model training (ref. 230) uses PPO with a learning rate of 0.0003, optimizing parameters (ref. 240) via gradient descent. The feedback loop (ref. 250) updates every 10 seconds for real-time refinement.

3. Interaction Adjustment Unit (FIG. 3, ref. 300) This unit processes real-time inputs (ref. 310), such as live tweet interactions, and tunes PPO weights (ref. 320). Behavior analysis (ref. 330) employs LSTM for pattern detection, adjustment validation (ref. 340) ensures statistical significance (p<0.05), and dynamic calibration (ref. 350) limits parameter shifts to 5% per cycle for stability.

4. Influence Optimizer (FIG. 4, ref. 400) This compiles scores (ref. 410) as weighted sums (e.g., score=0.5*Engagement+0.4*Trust+0.1*Governance), logs events via the timestamp module (ref. 420), stores data immutably on the Ethereum blockchain (ref. 430), applies differential privacy (ref. 440, E=1.0), and logs actions in tamper-proof records (ref. 450).

5. Output Interface (FIG. 5, ref. 500) This delivers scores (ref. 510) in JSON format, encrypted with AES-256 (ref. 520). The integration API (ref. 530) supports RESTful endpoints, result formatting (ref. 540) ensures JSON/XML compatibility, and secure transmission (ref. 550) uses TLS 1.3.

Integrated Description from Provisional Application

To ensure alignment with U.S. Provisional Patent Application No. 63/847,329, the following elements from the provisional are incorporated:
Initial Influence Policy Model: Defines initial score mappings based on network activity, credentials, and trust signals (aligns with refs. 100, 200).
Reinforcement Signal Generator: Extracts rewards from outcomes like endorsements and governance alignment (aligns with refs. 210, 220).
Policy Optimizer: Updates scoring parameters using PPO or DDPG (aligns with refs. 230, 240).
Feedback Loop Engine: Continuously adjusts learning pathways based on performance signals (aligns with refs. 250, 300).
Trust Calibration Layer: Prevents manipulation or overfitting via regularization (aligns with refs. 340, 440).

Operational Method. The RLE operates as follows:
1. Metric Aggregation (FIG. 1, ref. 100): Consolidates metrics (ref. 120), anonymizes data (ref. 130), verifies sources (ref. 140), and classifies metrics (ref. 150).
2. Reinforcement Learning (FIG. 2, ref. 200): Processes feedback (ref. 210), applies reward functions (ref. 220), trains models (ref. 230), optimizes parameters (ref. 240), and refines via feedback (ref. 250).
3. Interaction Adjustment (FIG. 3, ref. 300): Handles real-time inputs (ref. 310), tunes parameters (ref. 320), analyzes behavior (ref. 330), validates adjustments (ref. 340), and calibrates dynamically (ref. 350).
4. Score Optimization (FIG. 4, ref. 400): Compiles scores (ref. 410), timestamps events (ref. 420), stores immutably (ref. 430), applies privacy-preserving optimization (ref. 440), and logs actions (ref. 450).
5. Result Output (FIG. 5, ref. 500): Delivers scores (ref. 510), encrypts data (ref. 520), integrates via API (ref. 530), formats results (ref. 540), and transmits securely (ref. 550).

### Use-Case Example

In a decentralized autonomous organization (DAO) with 10,000 members, the RLE processes 1 million monthly interactions (e.g., likes, votes). It aggregates metrics like vote participation and endorsements, applies PPO-based RL to update scores every 10 seconds, and delivers JSON-formatted scores via RESTful APIs to allocate voting power, enabling responsive governance.

### Advantages

Real-Time Adaptability: 10-second RL feedback loops ensure dynamic scoring.
GDPR Compliance: SHA-256 anonymization and differential privacy (E=1.0).
Immutable Audit Trails: Ethereum blockchain ensures tamper-proof records.
Interoperability: RESTful APIs support JSON/XML outputs.
Dynamic Scoring: Enhances decentralized governance and reputation systems.

1. A computerized system for adaptive influence optimization (FIG. 1, ref. 100), comprising: one or more processors and memory storing instructions that, when executed, cause the system to: aggregate metrics via a metric aggregation module (ref. 100); apply reinforcement learning via a processor (FIG. 2, ref. 200); adjust interactions via an adjustment unit (FIG. 3, ref. 300); optimize scores via an influence optimizer (FIG. 4, ref. 400); and output results via an interface (FIG. 5, ref. 500).

2. A computer-implemented method for adaptive influence optimization (FIG. 1, ref. 100), comprising: aggregating metrics; applying reinforcement learning (FIG. 2, ref. 200); adjusting interactions (FIG. 3, ref. 300); optimizing scores (FIG. 4, ref. 400); and outputting results (FIG. 5, ref. 500).

3. A non-transitory computer-readable storage medium storing instructions that, when executed, perform a method for adaptive influence optimization (FIG. 1, ref. 100), comprising: aggregating metrics; applying reinforcement learning (FIG. 2, ref. 200); adjusting interactions (FIG. 3, ref. 300); optimizing scores (FIG. 4, ref. 400); and outputting results (FIG. 5, ref. 500).

4. The system of claim 1, wherein metrics include engagement, trust, and reputation scores from social platforms or blockchain ledgers.

5. The system of claim 1, wherein reinforcement learning uses a PPO-based reward function (FIG. 2, ref. 220) defined as R=0.6*Engagement+0.3*Trust+0.1*Governance.

6. The system of claim 1, wherein adjustments use LSTM-based behavior analysis (FIG. 3, ref. 330) for real-time tuning.

7. The system of claim 1, wherein optimization includes differential privacy (FIG. 4, ref. 440, ε=1.0) and audit logging (ref. 450).

8. The system of claim 1, wherein outputs support DAO governance via RESTful APIs (FIG. 5, ref. 530).

9. The system of claim 1, wherein models update dynamically with a 10-second feedback loop (FIG. 2, ref. 250).

10. The method of claim 2, wherein aggregating uses GDPR-compliant anonymization via SHA-256 (FIG. 1, ref. 130).

11. The method of claim 2, wherein learning applies PPO with a 0.0003 learning rate (FIG. 2, ref. 240).

12. The method of claim 2, wherein adjustments validate via statistical significance (FIG. 3, ref. 340, p<0.05).

13. The method of claim 2, wherein optimization stores immutable logs on Ethereum blockchain (FIG. 4, ref. 430).

14. The method of claim 2, wherein outputting uses AES-256 encryption and TLS 1.3 (FIG. 5, ref. 550).
